(19) United States
(12) Patent Application Publication
(10) Pub. No.: US 2011/0153436 A1
(43) Pub. Date: Jun. 23, 2011

(54) Method of establishing credit on a cash register

(76) Inventor: Richard L. Krampe, Winter Park, FL (US)

(21) Appl. No.: 12/807,438

(22) Filed: Sep. 7, 2010

Related U.S. Application Data
(63) Continuation-in-part of application No. 12/802,546, filed on Jun. 10, 2010.
Application No. 12/802,546 is a continuation-in-part of application No. 12/653,741, filed on Dec. 18, 2009.

(51) Int. Cl. G06Q 20/00

(52) U.S. Cl. 705/16

(57) ABSTRACT

A method is provided for paying for a product or service in a cash register with a credit card using a personal wireless communication device. The method includes loading vending universal wireless interface software into a cash register to interface with the case register microprocessor and an RF transceiver to control communication between the cash register and the personal wireless communication device so that the personal communication device can obtain transaction data from the cash register and communicate the data to a remote server for credit card approval for payment of the transaction so that the transaction can be executed by the cash register.

This application is continuation-in-part of U.S. patent application Ser. No. 12/802,546, filed Jun. 6, 2010 for Apparatus and Method of Establishing Credit on a Cash Register or Printer, which is a Continuation in Part of U.S. patent application Ser. No. 12/653,741, filed Dec. 18, 2009 for Method of Establishing Credit on a Vending Device.

### FIELD OF THE INVENTION

The present invention relates to establishing credit on a Cash Register or Cash Register System and especially to establishing a currency amount on a Cash Register or Cash Register System in order to pay for a product or services using a cellular telephone, or other personal wireless communication device, using an applet placed on the personal wireless communication device that can communicate, with a Software Version of a vending universal wireless interface (VUWI) device. The Software Version of a vending universal wireless interface (VUWI) device is a software Application Program Interface (API) or a Dynamic Link Library (DLL) or a combination thereof that runs on the Cash Register or Cash Register System's microprocessor in order to interface with its microprocessor or with other software being executed by the Cash Register or Cash Register's microprocessor and to control the Cash Register or Cash Register System's Bluetooth, WiFi or other RF Transceiver port as well as to control all communications between the Cash Register or Cash Register System and a cellular telephone, or other personal wireless communication device.

### BACKGROUND OF THE INVENTION

Cash Registers and Cash Register Systems have become commonplace in retail establishments which offer consumers a variety of products and services which the consumer must pay for using either currency or credit. The Cash Registers and Cash Register Systems become the temporary repository of whatever coins, paper currency, account credits vouchers, credit cards receipts, and debit card receipts used by the consumer to pay for the products or services offered by a retailer.

Cash Register and Cash Register Systems, hereinafter referred to as Registers, that accept credit cards and debit cards generally require an online or dial-up connection from the Register to the credit or debit card issuer, merchant bank or to a gateway service offering credit or debit card processing services. Any of these approaches can be used to verify the availability of funds or credit and thereby authorize the completion of the transaction at the Register. The online or dial-up connection to the Register must be secure and must generally be a dedicated connection that is available on demand to insure satisfactory transactions in terms of speed and reliability.

Cash Register Systems that accept credit cards often require the customer to surrender their credit card to an attendant, waiter, waitress, bartender, or other retail sales person in order to have the card swiped into the business' register system. This often puts the consumer's credit card out of direct visual contact and presents an opportunity for fraudulent use or misappropriation of the consumer's credit card or the information contained thereon.

A personal wireless communication device includes not only cell phones but also a personal digital assistant (PDA), IPOD, IPHONE, Smartphone, laptop computer or other similar personal wireless communication device, which can be used to communicate with a remote server.

In the past there have been attempts to vend or sell products or services without using cash but these have been primarily concerned with the use of credit cards in which the vending machine or cash register has a connection to the world wide internet or some other communication to approve the use of the credit card. One prior system as disclosed in the Whigham U.S. Pat. No. 6,584,309 is for a method of authorizing the purchase of a product from an automatic vending machine by means of a consumer's cellular telephone. In this system the consumer uses a cellular phone to request a product from a vending machine by dialing a specified telephone number to connect the consumer's phone to a server operated by a billing agency. The server identifies the product and creates a request for purchase of the product and a transaction record and sends a “vend code” to the consumer's cell phone, which allows the consumer to purchase the product.

Other systems using cellular telephone or wireless communication devices may be seen in the Johnson, Jr. U.S. Pat. No. 7,039,389, for a cellular telephone-based retail transaction system for dispensing fuel and in the Carapelli U.S. Pat. No. 7,574,377, for a vending system for vending to purchasers having cellular phones or the like enabled to a wireless internet connection for communication over the internet. The Zhu U.S. Pat. No. 7,577,616, provides for a method for secure authentication or electrical payment utilizing a random ID verification method through a mobile communication tool. U.S. Pat. No. 5,991,749, teaches a wireless telephony for collecting tolls, conducting financial transactions, and authorizing other activities. U.S. Pat. No. 7,164,884 uses a wireless interface module to interface with a vending machine control system to allow communication between vending machines and a wireless network by coupling a transceiver to the wireless interface module. The Khan et al U.S. Pat. No. 7,127,236 is for a micropayment financial transaction process utilizing wireless network processing while the McGarry et al. U.S. Pat. No. 6,038,491, is for a monitoring and reporting system using a cellular carrier.

Other prior U.S. patents include the Morrill, Jr. No. 5,991,749 for a wireless telephoney for collecting tolls, conducting financial transactions, and authorizing other activities and the Birch et al. U.S. Pat. No. 7,213,742 for a fuel dispensing system having a plurality of fuel dispensers capable of conducting a fueling transaction using a customer's cellular telephone.

My prior U.S. patent application Ser. No. 12/653,741 is for a Method of Establishing Credit on a Vending Device and establishes a currency amount on a vending machine in order to obtain a product or service using a cellular telephone or personal wireless communication device, using an applet placed on the personal wireless communication device that can communicate with a vending universal wireless device placed on the vending machine.

Also in U.S. patent application Ser. No. 12/802,546, an apparatus and method of establishing credit on a cash register or printer connects the vending universal wireless interface (VUWI) device to the serial or USB port of a cash register or printer in order to interface with the microprocessor of the cash register or printer.

The present invention relates to a Vending Universal Wireless Interface (VUWI) using software designed to run or be executed on the Cash Register or Cash Register System's microprocessor in order to control the Cash Register or Cash Register System's Bluetooth, Wi-Fi, Wireless LAN or other RF Transceiver port while interfacing with other software being executed by the Cash Register or Cash Register's microprocessor and communicating with a Cellular telephone or personal wireless communication device.

### SUMMARY OF THE INVENTION

A method of executing a transaction on a Cash Register or Cash Register System, by a consumer using a cellular phone or other wireless personal communication device by a consumer includes establishing and activating an applet on the cellular telephone to establish a wireless link with a cash register having software added thereto to form a vending universal wireless interface (VUWI). Once the software VUWI has been added to a cash register, a wireless link can be established between the wireless personal communication device and a computer server for transmitting a request from the wireless communication device to the computer server for approval of a transaction for use on the cash register. The computer server determines the credit availability of the transmitted request and generates a transaction record from the transmitted request and transmits a response from the computer server to the personal communication device authorizing a predetermined transaction for use on the cash register upon credit authorization of the transaction. The personal communication device then communicates the transaction approval to the vending universal wireless interface (VUWI) software which in turn communicates the approved amount to the cash register or cash register software to pay for the product or services required by the consumer.

A system for establishing credit on a cash register by a consumer using the consumer's cellular phone or wireless communication device uses the vending universal wireless interface software to run or execute the cash register's microprocessor controller. The wireless communication device has a local transceiver and an applet thereon for communication between the personal wireless communication device and the register's vending universal wireless interface software through the register's Bluetooth, Wi-Fi, Wireless LAN or other RF transceiver port. A remote computer server is linkable with the personal wireless communication device for receiving requests from the personal communication device for approval of a transaction on the cash register. The remote server is adapted to respond to approval for a register purchase and for instituting the creation of a transaction record from the request.

A system and method is provided for establishing credit on a cash register by means of a software Applet running on a consumer's cellular telephone and vending universal wireless interface software (VUWI) running or being executed by the cash register's microprocessor. If the consumer does not have the Applet, they can request a copy by dialing a specified telephone number which connects the consumer's cellular telephone to a server which is able to download the Applet to the consumer's cellular telephone. If the cash register does not have the software VUWI running or being executed by its microprocessor, then communication between the consumer's cellular telephone and the cash register is not possible.

If the cash register has the software VUWI and if the consumer has the Applet and wishes to obtain approval of a transaction on a cash register the consumer activates the Applet on their cellular telephone. The Applet then requests the consumer to enter on the keyboard of the cellular telephone the cash register receipt number that the consumer wishes to pay. The Applet establishes contact with the cash register through the software VUWI in order to secure its identity and a copy of the cash register receipt for products or services that is to be paid. The Applet then requests that the consumer enter on the keyboard of the cellular telephone any tip amount, if appropriate, that is to be added to the cash register receipt and then the total amount to be spent as well as a personal identification number (PIN), which the Applet forwards this information to a server for approval. The server recognizes the request for approval and verifies that the requesting Applet has the correct cellular telephone identification and the correct consumer PIN as well as a correct Register identity. The server then checks the consumer's credit account for available funds. The server then creates a transaction record for its history log and communicates an approval or denial code to the Applet on the consumer's cellular telephone. The Applet stores a receipt on the consumer's cellular telephone and displays the approval or denial status of the request on the consumer's cellular telephone's display screen. The Applet communicates the transaction approval or denial to the cash register through the VUWI software. The consumer then gets the merchant or retailer to print a new copy of the cash register Receipt and completes the payment by signing, if necessary, the new register receipt.

### BRIEF DESCRIPTION OF THE DRAWINGS

Other objects, features and advantages of the present invention will be apparent from the written description and the drawings in which:

FIG. 1 is a diagram of the present system for establishing currency amount on a Cash Register or Cash Register System using a cellular telephone;

FIG. 2 is a flow chart of the present method of establishing a currency amount on a Cash Register or Cash Register System using a cellular telephone; and

FIG. 3 is a flow diagram of the Software for a Vending Universal Wireless Interface (VUWI) that is incorporated into a Cash Register or Cash Register System that allows the establishing of a currency amount on the Cash Register or Cash Register System using a cellular telephone.

### DETAILED DESCRIPTION OF THE EXEMPLARY EMBODIMENTS

An exemplary embodiment of the present invention will hereinafter be described with reference to the drawings, in which like numerals indicate like elements throughout the drawing figures.

The present invention is a method and system for establishing a currency value on a Cash Register or Cash Register System, hereinafter referred to as a Register, by using the consumer's cellular telephone equipped with Bluetooth, Wi-Fi, wireless LAN or other RF communication capabilities, which cellular telephone may be in the form of a cellular telephone, a personal digital assistant (PDA), IPOD, IPHONE, Smartphone, Laptop computer or other similar personal wireless communication device any of which must be equipped with Bluetooth, Wi-Fi, wireless LAN or other RF communication capabilities, hereinafter collectively called “cellular telephone” as a link between the consumer, the register and a server supported credit account, which server is a general purpose digital computer system capable of receiving input from and providing output to a cellular or IP-Based communication network and may be operated by the consumer's telephone company, by the consumer's bank, by the consumer's credit or debit card issuer, by a retail outlet offering credit and/or gift and/or loyalty accounts to the consumer, by a merchant bank or gateway service provider offering credit and/or debit card processing services on behalf of the consumer's telephone company, the consumer's bank, the consumer's credit or debit card issuer, or a retail outlet offering credit and/or gift and/or loyalty accounts to the consumer hereinafter collectively called “server”. The server supported credit account may be an account held by the consumer with the consumer's telephone company; with the consumer's bank, with the consumer's credit or debit card issuer; with a retail outlet offering credit and/or gift and/or loyalty accounts to the consumer hereinafter collectively called “credit account”. In addition, the credit account can be a mobile wallet supported on the consumer's cellular telephone.

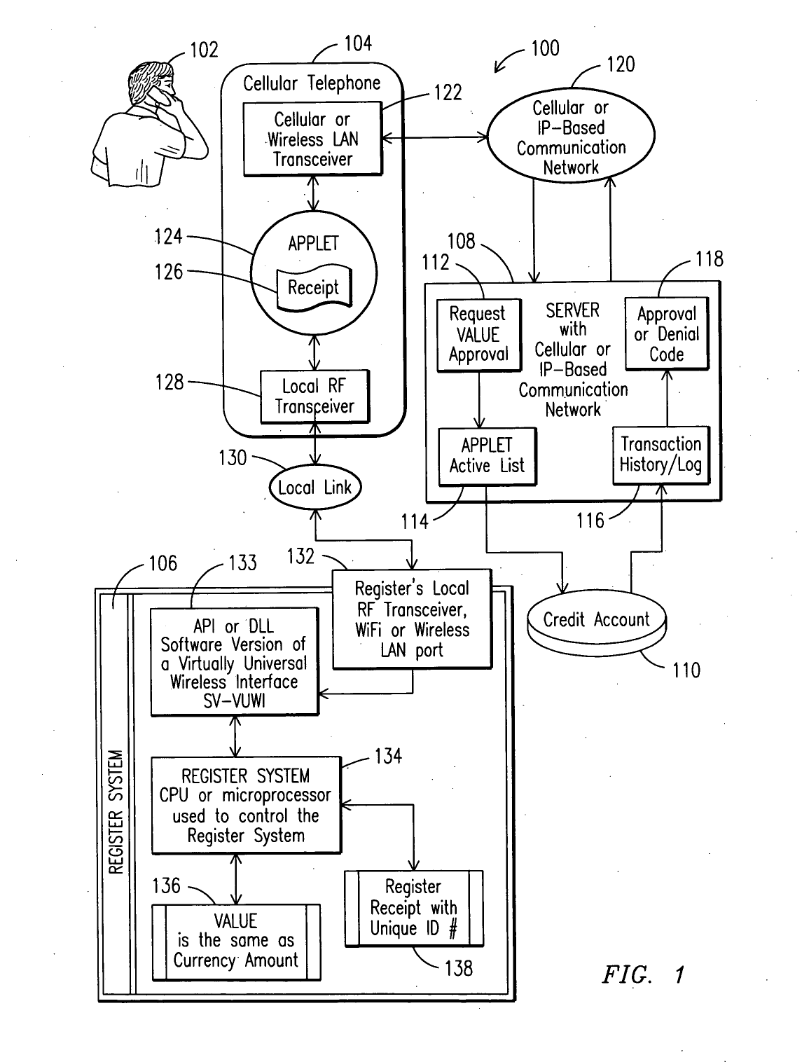

FIG. 1 shows the system 100 of the present invention. System 100 is configured to allow a consumer 102 to load a transaction amount 136 to a cash register 106. For the purposes of this invention, the term “value” means the currency amount available to the consumer 102 through the register 106. System 100 has a cash register 106 having an external or internal Bluetooth, Wi-Fi, wireless LAN or other RF transceiver Port 132, and software version of an API/DLL Vending Universal Wireless Interface (VUWI) 133. A register normally does not have a bluetooth, Wi-Fi or RF Transceiver but can have one added thereto with a plug in to USB port. A cellular telephone 104 associated with a consumer 102, has a local RF Transceiver 128 and a cellular or wireless LAN transceiver 122, and a remote server 108.

The consumer's cellular telephone 104 is connected to the register 106 via the cellular telephone's local RF transmitter 128, local communication link 130, which is a short range RF communication link. The register's local RF, WIFI or other wireless LAN Port 132 is controlled by Virtually Universal Wireless Interface (VUWI) 133 software being run on the register's microprocessor 134. The consumer's cellular telephone 104 is also connected to the server 108 via the cellular telephone's cellular or wireless LAN transceiver 122 and the cellular or IP-based communication network 120. The cellular or IP-based communication network 120 allows the consumer 102 to use their cellular telephone 104 to establish a connection with server 108.

When a consumer 102 is ready to pay for products or services provided by a retailer or merchant at a cash register 106 three possibilities exist. First, the cash register 106 does not have the ability to accept a currency amount from a cellular telephone 104 and there is no action possible in connection with this invention.

Second, the cash register 106 can accept currency amounts from a cellular telephone 104 but the consumer 102 does not have the required Applet 124 on their cellular telephone 104. If the consumer 102 decides to download the Applet 124 he follows the following procedure. The consumer 102 calls the telephone number displayed on or near the cash register 106 in order to connect to the server 108. Once the consumer dials the displayed number and the call is received by the server 108, the server 108 makes an automated verbal request through the consumer's cellular telephone 104 for confirmation from the consumer that they wish to download an Applet 124 to be used for making cashless purchases on a cash register 106. The consumer can respond by pressing a particular key or keys on the keyboard of the cellular telephone 104 or by answering “Yes” verbally over the cellular telephone 104. If the correct key or keys are pressed or the verbal response of “Yes” is provided the server 108, the server downloads the Applet 124 and verbally tells the consumer to follow the activation directions on the display screen of the cellular telephone 104 that will be provided by the Applet 124. Once activated, the consumer 102 can use the Applet 124 for making cashless purchases on a cash register 106. If the correct key or keys are not pressed or the verbal response of “Yes” is not provided, the server 108 hangs up ending the call.

Third, the register 106 can accept a currency amount from a cellular telephone 104 and the consumer 102 has the required Applet 124 on their cellular telephone 104. If the consumer 102 decides to make a cashless payment at the register 106, the consumer follows the following procedure. The consumer 102 activates the Applet 124 on their cellular telephone 104. The Applet 124 will request that the consumer 102, after reviewing a preliminary copy of the cash register receipt 138, enter the unique receipt number contained thereon into the Applet screen using the cellular telephone's keyboard. Then, the Applet 124, using the cellular telephone's local RF Transceiver 128, connects to the cash register's local RF, WIFI or other wireless LAN Port 132 being controlled by the software Virtually Universal Wireless Interface (VUWI) 133 being run on the register's microprocessor 134, to establish a two-way communication link 130 between the cellular telephone 104 and the cash register 106. The Applet 124 acquires from the register's microprocessor 134 the cash register's 106 identification information and a copy of the cash register receipt 138 identified by the unique cash register receipt number provided by the consumer 102 and transfers this information to the cellular telephone 104 and displays the cash register receipt 138 on the cellular telephone's display screen. The consumer 102 can then review the cash register receipt on the cellular telephone's 104 display screen. If acceptable the consumer 102 follows the instructions provided by the Applet 124 on the cellular telephone's display screen and using the cellular telephone's keyboard enters, if appropriate, any tip they wish to have added to the register receipts product or services total. The Applet 124 will then display the total owed the retailer or merchant for the displayed register receipt plus tip and ask the consumer 102 to either accept or reject the total amount shown. If rejected the Applet 124 redisplays the register receipt and allows the consumer 102 to either cancel the transaction to re-enter any tip value and continue with the transaction. If accepted the Applet 124, using the cellular telephone's 104 cellular or wireless LAN transceiver 122 establishes a two-way communications link using the cellular or IP-based communication network 120 with the server 108. The server 108 uses the two-way communication link to established via the cellular or IP-based communication network 120 data from the Applet 124 along with the identification information of the cellular telephone 104 and the identification information of the register 106 and the tip value added to the register receipt and the total value 136 requested by the consumer 102 in approving the credit for the register 106. The server 108 processes the request for approval 112 of the value 136 requested by the consumer 102 by referencing the consumer 102 server supported credit account 110, which it controls, either directly or indirectly. Once the server 108 has checked for the availability of total value 136 on the consumer's credit account 110, the server 108 generates an approval or denial code 118 and further creates a transaction record 116 as a history or log of the activity which includes the details about the request including the cellular telephone 104 identification information, the consumer's confirmation or identification information such as a personal identification number (PIN), the cash register's 106 identification information, the total value 136 to be authorized, the amount of the tip that was added to the cash register receipt, the time and date of the request and finally the approved or denied code.

The approval or denial code 118 is communicated to the consumer 102 via the cellular or IP-based communication network 120 and the consumer's cellular telephone 104. The approval code 118, the tip amount and the total value 136 as approved for use on the register 106 is in-turn transmitted to the register 106 via the cellular telephone's 104 local transmitter 128 using the local link 130 which is received by the register 106 local RF, WIFI or other wireless LAN Port 132 which is being controlled by a Software Version of a Virtually Universal Wireless Interface (VUWI) 133 running on the register's microprocessor 134 which in turn informs the register's 106 microprocessor controller 134 of the approval code 118, tip amount and the overall total value 136 the consumer 102 has made available to complete the payment process. The cash register's microprocessor controller 134 receives approval code 118, the tip amount and the overall total value 136 and upon request can print a new updated register receipt 138 for the consumer. The retailer or merchant then presents the new updated register receipt 138 to the consumer 102 and if appropriate secures the consumer's 102 signature on the final cash register receipt. It should also be noted that in accordance with the system of the present invention, there is no dedicated communication link required between the cash register 106 and the server 108 that authorizes the payment on the cash register 106. In addition, the consumer 102 was never required to present or be physically separated from their credit or debit 21, card.

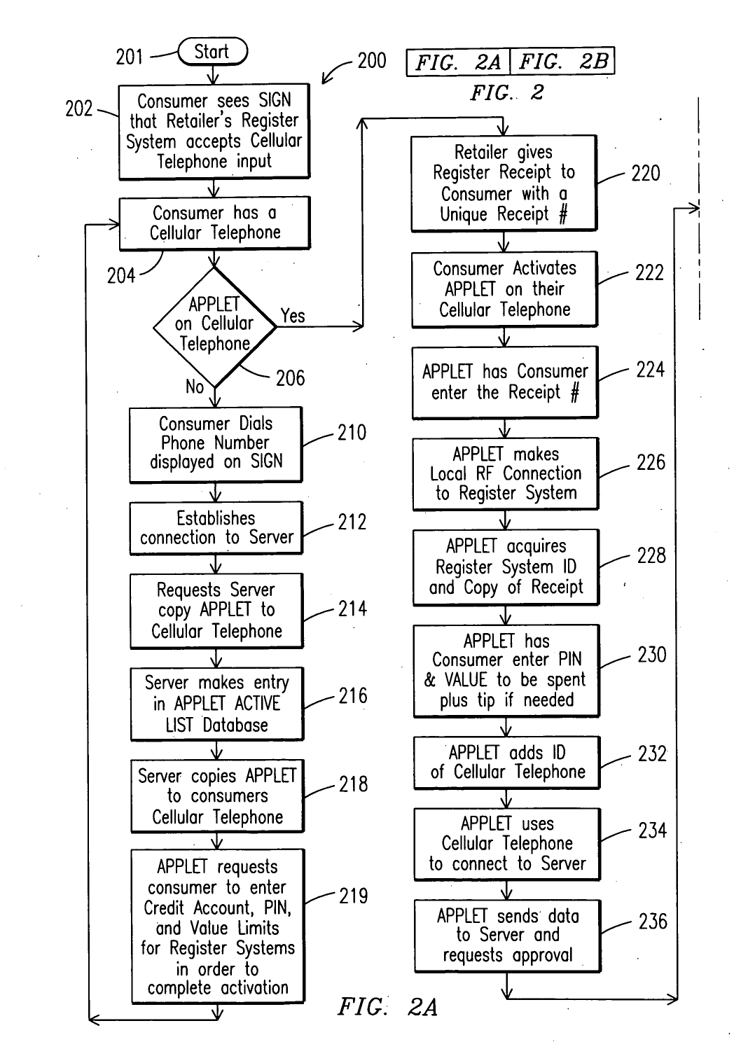

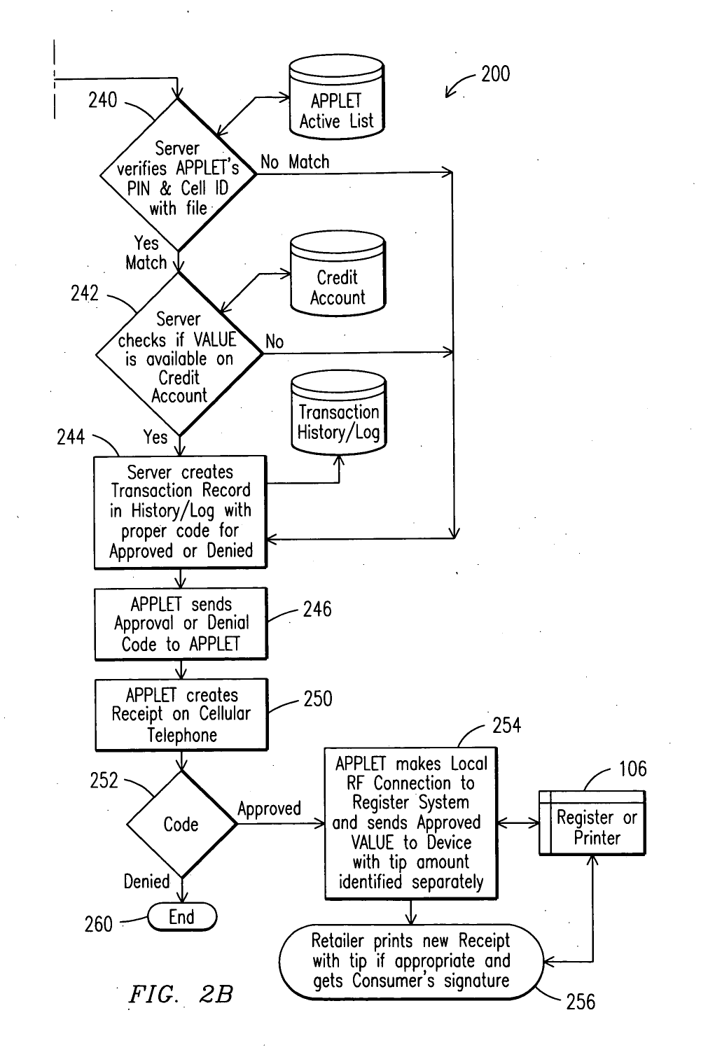

Turning to FIG. 2, a method 200 allows the consumer 102 to establish credit or value 136 on a cash register 106 by using their cellular telephone 104. Using the established credit or value 136, the consumer 102 is able to pay for products or services at any cash register 106 equipped with a local RF, WIFI or other wireless LAN Port 132 which is controlled by Software creating a Virtually Universal Wireless Interface (VUWI) 133 being running on the register's microprocessor 134. The method 200 begins at step 201 and proceeds to step 202 when the consumer sees a register that accepts a cellular telephone input. At step 202, the consumer 102 sees a register 106 that accepts a cellular telephone 104 input of credits or value 136 as payment for products or services. Information displayed on or adjacent to the register 106 provides instructions for using the consumer's cellular telephone 104 to establish credit on the cash register 106.

The instructions include a telephone number to call for downloading of an Applet 124 that will run on the consumer's cellular telephone 104 and allow the consumer 102 to establish credit or value 136 on the cash register 106. If the consumer 102 already has the Applet 124 on their cellular telephone 104, the method proceeds to step 220 to where consumer 102 acquires a copy of the cash register receipt 138 containing a unique receipt number and details of their purchase. Otherwise at step 210, the consumer 102 dials the number displayed on the sign to make a telephone connection between the cellular telephone 104 and the server 108 via cellular or IP-based communication network 120. A connection is made with the server 108 at step 212 over the cellular or IP-Based communication network 120. The consumer 102 requests, in step 214, that the server 108 download the Applet 124 to their cellular telephone 104. The server 108 in step 214 makes an entry into its Applet active list 114 and the server 108 in step 218 downloads the Applet 124 to the consumer's cellular telephone 104 and instructs the consumer to follow the instructions displayed on their cellular telephone 104. The Applet in step 219 asks the consumer 102 to input a credit account number, its expiration date and its card verification value (CVV) code, which credit account will be used when paying for products or services at a register 106. The Applet 124 also requests entry of dollar limits to be associated with various types of registers 106 and a personal identification number (PIN) to be used when using the Applet 124 to pay for products or services at a register 106. Once the Applet 124 requests have been answered and entered by the consumer 102 on the cellular telephone's keyboard, the Applet 124 contacts the server 108 and uploads the information to the server 108 to store in the Applet active list 114. All of the information entered to the Applet 124 is cleared from and not stored on the cellular telephone 104. If the consumer 102 has the Applet on their cellular telephone 104 the consumer 102 moves to step 220 to begin the payment process at the register 106.

If the Applet 124 is on the consumer's cellular telephone 104, the consumer 102 then acquires a copy of the cash register receipt 138 from the retailer which receipt contains a unique receipt number in step 220 and then the consumer 102 in step 222 activates the Applet 124 on the cellular telephone. The Applet 124 in step 224 has the consumer 102 enter the unique register receipt number from the cash register receipt 138 on the cellular telephone's 104 keyboard and then the Applet 124 in step 226 makes a connection to the cash register 106, equipped with a local RF, WIFI or other wireless LAN Port 132 controlled by a Software Virtually Universal Wireless Interface (VUWI) 133 running on the register's microprocessor 134, using the cellular telephone's local RF transceiver 128 and the local link 130. Once the connection is established between the Applet 124 and the cash register 106 in step 228, the Applet 124 acquires the cash register's 106 identification information and a copy of the register receipt 138 which contains information about the product's or services the consumer 102 is about to pay for using their cellular telephone 104. The Applet 124 then displays this register receipt 138 for the consumer 102 on the cellular telephone's 104 display screen and requests in step 230 that the consumer 102 enter their personal identification number (PIN), and a tip amount, if needed to the cellular telephone's 104 keyboard and then a new receipt total is displayed for the consumer 102. The consumer 102 is asked to accept or reject the new total. If rejected the preliminary transaction is canceled. If accepted, the Applet 124 in step 232 adds the ID of the cellular telephone 104 and continues in step 234 using the cellular telephone's 104 cellular or wireless LAN transceiver 122 to make a connection through the cellular or IP-based communication network 120 with the server 108. Once the connection is established in step 234, the Applet 124 in step 236 transfers the consumer's personal identification number (PIN) and the cellular telephone's identification information and the register's 106 identification information, along with the tip amount, if any and the total value 136 requested by the consumer 102 to the server 108 and requests approval for the transaction. The server 108 in step 240 checks to make sure the Applet 124 making the request is coming from the consumer 102 and cellular telephone 104 that the server 108 currently associates with the Applet 124.

The server 108 in step 240 compares the transmitted consumer identification number (PIN) and the cellular telephone's identification information with the data it has stored on its Applet active list 114. If the information matches the server 108, it continues with step 242 to check if the value is available on the consumer's credit account. The server 108 checks in step 242 to see if the value 136 requested by the consumer 102 is available on the consumer's credit account 110. The server 108 then continues with step 244 where it creates a transaction record to be placed in the transaction history/log 116. Based on the results of the two tests it made in steps 240 and 242, the server also attaches an Approved or Denied code to the transaction record. The server 108 in step 246 sends an approval or denial code to the Applet 124. The Applet 124 in step 250 creates a receipt for reference by the consumer 102 on the consumer's cellular telephone 104. The Applet 124 in step 252 checks the Approved or Denied Code sent by the server 108 and if the transaction was denied the Applet 124 displays a request denied message to the consumer 102 on the consumer's cellular telephone's 104 display screen and the transaction is ended. If the transaction was Approved, the Applet 124 in step 254 establishes contact with the cash register 106 using the cellular telephone's local RF transceiver 128 through the local link 130 to establish a connection to the cash register 106 through its local RF, WIFI or other wireless LAN Port 132 being controlled by a Software Virtually Universal Wireless Interface (VUWI) 133 being running on the register's microprocessor 134 and communicates the tip amount, if any, the Approved or Denied Code 118 and the approved total value 136 to the VUWI 133 which in turn sends the value 136 to the cash register's 106 microprocessor controller 134. The register 106 through its microprocessor controller 134 accepts the payment and provides the retailer with an updated register receipt 138 which the retailer provides to the consumer 102: If necessary, the retailer obtains the consumer's signature on the updated cash register receipt 138.

The credit account 110 used herein and supported by the server 108 may be an account held by the consumer with the consumer's telephone company; with the consumer's bank, with the consumer's credit or debit card issuer; with a retail outlet offering credit and/or gift and/or loyalty accounts to the consumer or be credit held as part of a mobile wallet on the consumer's cellular telephone.

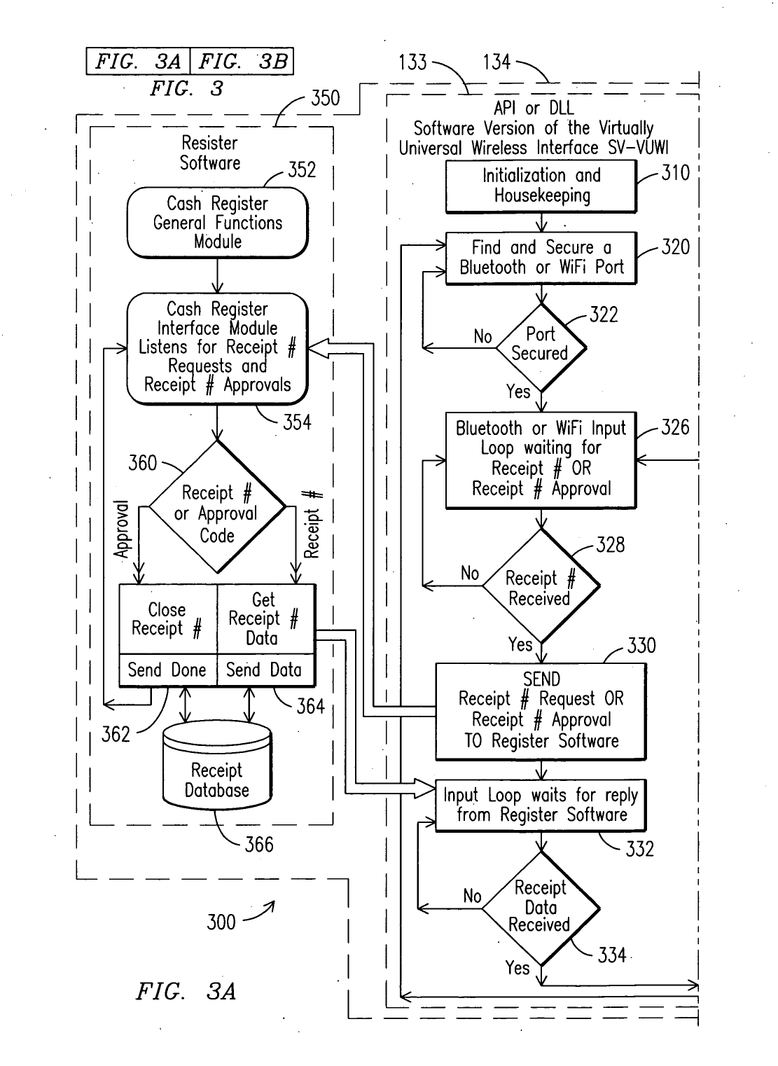

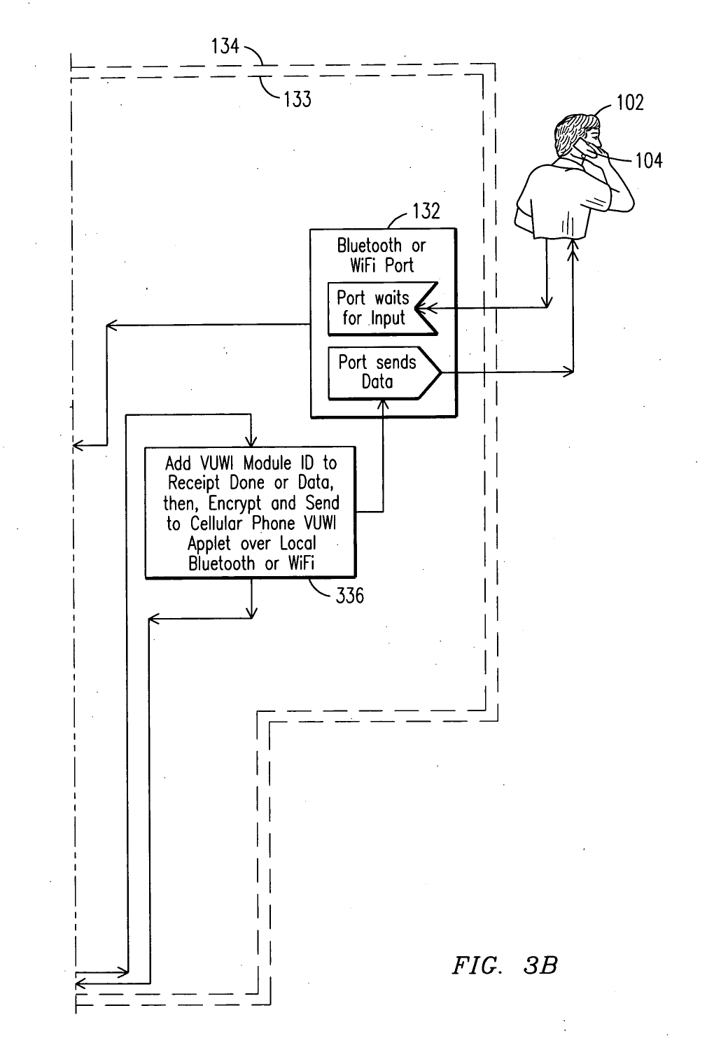

Referring to FIGS. 3 and 1, a Flow diagram of the software version of the vending universal wireless interface (SV-VUWI) 133 of the present invention. The software SV-VUWI 133 is designed to allow a consumer's cellular telephone 104 to communicate locally with a cash register 106 of FIG. 1. The Software SV-VUWI 133 is run or executed on the register's microprocessor 134 to control the register's local RF, WIFI or other wireless LAN Port 132 to provide an interface between the cellular telephone 104 and the cash register 106 microprocessor controller 134 to transfer value thereto.

The software SV-VUWI 133 is a software Application Program Interface (API) or a Dynamic Link Library (DLL) or a combination thereof that runs on the Register's microprocessor in order to interface with its microprocessor or with other software being executed by the Register's microprocessor and controls the Register's Bluetooth, WiFi or other RF Transceiver port as well as, controls all communications between the Register and a cellular telephone, or other personal wireless communication device.

Normal operation of the software of the vending universal wireless interface (VUWI) 300 requires loading the software SV-VUWI 133 onto the register's 106 microprocessor 134. The CPU or microprocessor 134 allows the software SV-VUWI 133 to initialize and take control of the register 106 (FIG. 1) local Bluetooth, WIFI, or other wireless RF transceiver 132 for the purpose of communication with a cellular telephone's 104 applet 124 through the cellular telephone's 104 local RF transceiver 128 across a local link 130 (FIG. 1). The SV-VUWI 133 establishes an internal communications link with other Register Software 350 running on or executing on the register's 106 microprocessor 134 for the purpose of exchanging information such as the identity of the register 106, the details about a specific register receipt 138 as requested by the consumer 102 and the approval or denial code 118 and approved value 136 information necessary for the microprocessor 134 to complete a transaction with the consumer 102. The SV-VUWI 133 sets the register's 106 RF transceiver or wireless LAN 132 to make itself available to establish a connection to cellular telephone 104. A customer 102 establishes a connection with transceiver 132 through a cellular telephone 104 by activating the Applet 124. The SV-VUWI 133 provides machine identification information to the Applet 124 running on the cellular telephone 104 over the transceiver 132 and the local link 130. Optionally the SV-VUWI 133 can also provide data collected from the register's 106 microprocessor 134 to the Applet 124 running on the cellular telephone 104 by transceiver 132 and the local link 130. The Applet 124 requests, on the cellular telephone's display screen, that the consumer enter value 136 to be spent on the register 106 using the cellular telephone's 104 keyboard. The Applet 124 then sends a request for approval along with all other data details to the server 108 for authorization over the cellular telephone's 104 cellular or wireless LAN transceiver 122 over the cellular or IP-based communications network 120. The server 108 then processes the request and responds to the Applet 124 running on the cellular telephone 104. If the Applet 124 detects that the request was approved it will communicate the approved value 136 to the register 106 over the cellular telephone's local RF transceiver 128 through the local link 130 to the cash register's transceiver 132, which will in turn transfer the value 136 to the register's 106 CPU or microprocessor 134 thru the SV-VUWI 133. The register microprocessor 134 will then handle the payment by the consumer 102 as if the consumer 102 had actually swiped a credit/debit card to make the payment on the cash register 106.

Using the SV-VUWI 133 of the present invention allows the consumer 102 to establish a currency amount on a cash register 106 in order to pay for products or services without using currency or a credit card but by only using a cellular telephone 104 which through the SV-VUWI 133 is able to communicate with the cash register 106. The method using the SV-VUWI 133 eliminates the need for in pocket currency or for a dedicated communication link between the cash register 106 and a credit account 110.

FIG. 3 is a flow diagram of the software addition or modification to the cash register's micro-processor 134 register software 350 and the SV-VUWI software module 133. The register has an RF transceiver 132 such as Bluetooth or a WiFi port which may be added to the register's USB port with a Flash memory module for communication with the cell phone 104 of a customer 102. The local RF transceiver waits for an input from the local transmission from a cellphone 104 for the software. The software SV-VUWI 133 initializes at 310 and the finds and secures (320) the RF transceiver 132 and secures the port (322). The secured port then awaits for a Receipt number or Receipt number approval (326) from the Bluetooth or WIFi. When a Receipt number is received (328) it send the receipt number request or receipt number approval (330) to the register software 350. The cash register software general function module 352 has a cash register interface module 354 added to listen for a receipt number request and receipt number approval. Once the receipt number request or receipt number approval code is received (360) the receipt number data Sends the data (364 for approval which is stored on a receipt data base 366. The receipt number approval closes the receipt number (362) and saves the receipt number on the Receipt Data base 366. The receipt number data is sent to the input loop which awaits for a reply form the register software (332). When the receipt data is received (334) it adds the VUWI Module ID to the receipt done or data, then encrypts and sends (336) the data to the cellular phone VUWI Applet over the RF Transceiver 132.

This addition of software to the Cash register's micro-processor along with the addition of a bluetooth or WiFi port to a cash register allows a customer 102 using his cell phone with an applet added thereto to complete a credit transaction remotely and without giving up his credit card and the requirement for additional hardware and modifications to an existing cash register. If the cash register does not have bluetooth or a wifi port built in, it can be easily added with a simple plug into a USB port.

It should be clear at this time that the present invention eliminates the need for in pocket currency or in hand credit/debit cards for paying for purchases at a cash register and also eliminates the need for a dedicated on-line or dial up connection between the register and a server supported credit account by using a consumer's personal communication device equipped with RF communication capability. In addition, the consumer is not required to relinquish control over their credit/debit card thus elimination the possibility of fraudulent use of the credit/debit card or its information while out of the hands of the consumer or in the hands of a third party. However the present invention is not to be construed as limited to the forms shown which are to be considered illustrative rather than restrictive.

I claim:

1. A method of paying for a product or service on a cash register with a credit card using a personal wireless communication device comprising the steps of:
selecting a cash register having a microprocessor and cash register control software for controlling transactions on said cash register and having an RF transceiver, said cash register being operative to accept payment by credit cards;
selecting a personal wireless communication device having an applet thereon to establish a wireless link between said personal wireless communication device and a remote server and between said personal wireless communication device and said cash register;
loading vending universal wireless interface software onto said cash register to interface with said cash register microprocessor and RF transceiver for controlling communication between said cash register and said personal wireless communication device for said personal communication device to obtain transaction data from said cash register;
communicating said obtained transaction data from said personal wireless communication device to a remote server for credit card approval for payment of a transaction;
communicating a transaction approval from said remote server to said personal wireless communication device and from said personal communication device to said cash register; and
executing said approved cash register transaction;
whereby a credit card transaction can be carried out on a cash register using a personal wireless communication device.

2. The method of paying for a product or service on a cash register with a credit card using a personal wireless communication device in accordance with claim 1 in which said loaded vending universal wireless interface software controls said RF transceiver to accept a request for a receipt number from said personal wireless communication device and to transmit a receipt number to said personal wireless communication device.

3. The method of paying for a product or service on a cash register with a credit card using a personal wireless communication device in accordance with claim 2 in which said loaded vending universal wireless interface software controls said RF transceiver to receive a receipt number approval from said personal wireless communication device.

4. The method of paying for a product or service on a cash register with a credit card using a personal wireless communication device in accordance with claim 3 in which said loaded vending universal wireless interface software obtains a receipt number from said cash register software for transmission to said personal wireless communication device.

5. The method of paying for a product or service on a cash register with a credit card using a personal wireless communication device in accordance with claim 4 in which said loaded vending universal wireless interface software sends a received receipt number approval to said cash register software for actuating said cash register to execute the cash register transaction.

6. The method of paying for a product or service on a cash register with a credit card using a personal wireless communication device in accordance with claim 5 in which the step of selecting a cash register having an RF transceiver includes selecting a cash register having blue tooth RF transceiver.

7. The method of paying for a product or service on a cash register with a credit card using a personal wireless communication device in accordance with claim 5 in which the step of selecting a cash register having an RF transceiver includes selecting a cash register having a WiFi RF transceiver.

8. The method of paying for a product or service on a cash register with a credit card using a personal wireless communication device in accordance with claim 5 includes the step of adding a cash register interface to said cash register software to receive a receipt number request from said vending universal wireless interface software upon said vending universal wireless software receiving the receipt number request from said personal wireless communication device.

9. The method of paying for a product or service on a cash register with a credit card using a personal wireless communication device in accordance with claim 8 includes the step of modifying said cash register software to send to said vending universal wireless interface software a receipt number for transmission to said personal personal wireless communication device.

10. A method of paying for a product or service on a cash register with a credit card using a personal wireless communication device comprising:
selecting a cash register having a microprocessor and cash register control software for controlling transactions on said cash register and operative to accept payment by credit card;
attaching an RF transceiver to the USB port of said cash register;
selecting a personal wireless communication device having an applet thereon to establish a wireless link between said personal wireless communication device and a remote server and between said personal wireless communication device and said cash register;
loading vending universal wireless interface software onto said cash register to interface with said cash register microprocessor and RF transceiver for controlling communication between said cash register and said personal wireless communication device for said personal communication device to obtain transaction data from said cash register;
communicating said obtained transaction data from said personal wireless communication device to a remote server for credit card approval for payment of a transaction;
communicating a transaction approval from said remote server to said personal wireless communication device and from said personal communication device to said cash register; and
executing said approved cash register transaction;
whereby a credit card transaction can be carried out on a cash register using a personal wireless communication device.

11. The method of paying for a product or service on a cash register with a credit card using a personal wireless communication device in accordance with claim 10 in which the step of attaching an RF transceiver to the USB port of said cash register includes attaching a blue tooth RF transceiver to the USB port of said cash register.

12. The method of paying for a product or service on a cash register with a credit card using a personal wireless communication device in accordance with claim 10 in which the step of attaching an RF transceiver to the USB port of said cash register includes attaching a WiFi RF transceiver to the USB port of said cash register.

13. The method of paying for a product or service on a cash register with a credit card using a personal wireless communication device in accordance with claim 10 in which the step of selecting a personal wireless device includes selecting a cellular telephone.
